(19) United States
(12) Patent Application Publication
(10) Pub. No.: US 2024/0184488 A1
(43) Pub. Date: Jun. 6, 2024

(54) APP LAUNCH DETECTION FROM READ CHUNK ANALYSIS

(71) Applicant: Micron Technology, Inc., Boise, ID (US)

(72) Inventors: Marco Onorato, Villasanta (MB) (IT); Luca Porzio, Casalnuovo (NA) (IT); Roberto Izzi, Caserta (IT)

(21) Appl. No.: 18/527,041

(22) Filed: Dec. 1, 2023

Related U.S. Application Data
(60) Provisional application No. 63/430,276, filed on Dec. 5, 2022.

(51) Int. Cl. G06F 3/06

(52) U.S. Cl. CPC G06F 3/0659; G06F 3/0613; G06F 3/0631; G06F 3/0679

(57) ABSTRACT

Methods, systems, and devices for app launch detection from read chunk analysis are described. Read commands may be received for accessing data stored in a memory system. The read commands may be used to determine a distribution of sizes for associated read data over an interval of time based, at least in part, on receiving the read commands. The memory system may detect the launch of an application based in part on the distribution of the sizes of the read data over the interval of time. Upon detecting the launch of the application, a procedure may be performed to reduce a duration associated with launching the application.

### CROSS REFERENCE

The present Application for Patent claims the benefit of U.S. Provisional Patent Application No. 63/430,276 by IZZI et al., entitled “APP LAUNCH DETECTION FROM READ CHUNK ANALYSIS,” filed Dec. 5, 2022, assigned to the assignee hereof, and expressly incorporated by reference herein.

### TECHNICAL FIELD

The following relates to one or more systems for memory, including app launch detection from read chunk analysis.

### BACKGROUND

Memory devices are widely used to store information in various electronic devices such as computers, user devices, wireless communication devices, cameras, digital displays, and the like. Information is stored by programming memory cells within a memory device to various states. For example, binary memory cells may be programmed to one of two supported states, often corresponding to a logic 1 or a logic 0. In some examples, a single memory cell may support more than two possible states, any one of which may be stored by the memory cell. To access information stored by a memory device, a component may read (e.g., sense, detect, retrieve, identify, determine, evaluate) the state of one or more memory cells within the memory device. To store information, a component may write (e.g., program, set, assign) one or more memory cells within the memory device to corresponding states.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), 3-dimensional cross-point memory (3D cross point), not-or (NOR) and not-and (NAND) memory devices, and others. Memory devices may be described in terms of volatile configurations or non-volatile configurations. Volatile memory cells (e.g., DRAM) may lose their programmed states over time unless they are periodically refreshed by an external power source. Non-volatile memory cells (e.g., NAND) may maintain their programmed states for extended periods of time even in the absence of an external power source.

### BRIEF DESCRIPTION OF THE DRAWINGS

FIG. 1 illustrates an example of a system that supports app launch detection from read chunk analysis in accordance with examples as disclosed herein.

FIG. 2 illustrates a chart showing read command and read chunk analysis that support app launch detection in accordance with examples as disclosed herein.

FIG. 3 illustrates a flowchart showing steps of a method that supports app launch detection from read chunk analysis in accordance with examples as disclosed herein.

FIG. 4 illustrates a block diagram of a memory system that supports app launch detection from read chunk analysis in accordance with examples as disclosed herein.

FIG. 5 illustrates a flowchart showing a method or methods that support app launch detection from read chunk analysis in accordance with examples as disclosed herein.

### DETAILED DESCRIPTION

Memory systems such as managed NAND (MNAND) devices can provide various benefits. Certain conditions may arise, however, which reduce such benefits. One such condition is associated with the launch of processes, such as applications (i.e., apps). Various platforms (or devices, systems, etc.) that include NAND and/or MNAND devices may experience latency during the launch of applications due, at least in part, to the increased level of read traffic activity associated with the memory device. Such delays may adversely affect user experience depending on the applications being launched. Delays associated with commonly used applications, for example, may affect users more adversely than delays associated with applications used at a lower frequency. An ability to identify or detect the launch of an application may enable or facilitate one or more responses that reduce latency associated with the launch of applications and improve management of organization of data stored in the memory device.

Techniques are described herein for detecting the launch of applications based on analysis of read chunks (or read data sizes). According to the disclosed examples and techniques, the memory system may receive read commands for accessing data stored therein. The memory system may determine and analyze a distribution of sizes of read data associated with the read commands received over an interval of time. Based on the analysis, the memory system may identify (or detect) the launch of an application and perform one or more procedures for reducing a duration associated with the application being launched. The procedures performed by the memory system may include monitoring commands being received by the memory system in order to identify read commands for accessing data. The read commands may be accumulated to obtain a distribution of sizes for read data (or read chunk) associated with the read commands. The distribution of sizes may be subsequently analyzed to determine if an application has been launched based on certain conditions being satisfied within a time interval.

The conditions may be based on detected values for the number of read commands, the size of the read data, or both. The conditions may also be based on variations in the detected values between different or successive intervals. If an application launch is detected, various procedures may be performed to reduce the amount of time (or duration) associated with launching the application. Some procedures may reallocate resources, while other procedures may improve management of read data stored in the memory system. Application launches may also be analyzed over time to improve management of read data stored in the memory system for some or all applications.

In addition to applicability in memory systems as described herein, techniques for app launch detection from read chunk analysis may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving management of read data stored in the memory system, among other benefits.

In addition to applicability in memory systems as described herein, techniques for app launch detection from read chunk analysis may be generally implemented to support edge computing applications. Edge computing is a distributed computing paradigm that brings computation and data storage closer to the sources of data than traditional cloud services. As the use of edge computing to provide computing, storage, and networking services at locations that are geographically closer to end users increases, many devices and systems may benefit from improved processing, performance, and storage at edge devices. For example, increasing memory density, capacity, and processing power of edge devices may decrease a reliance on the devices to remote computing or devices, which may otherwise increase latency of operations performed at the devices. Implementing the techniques described herein may support edge computing techniques by improving management of read data stored in the memory system, among other benefits.

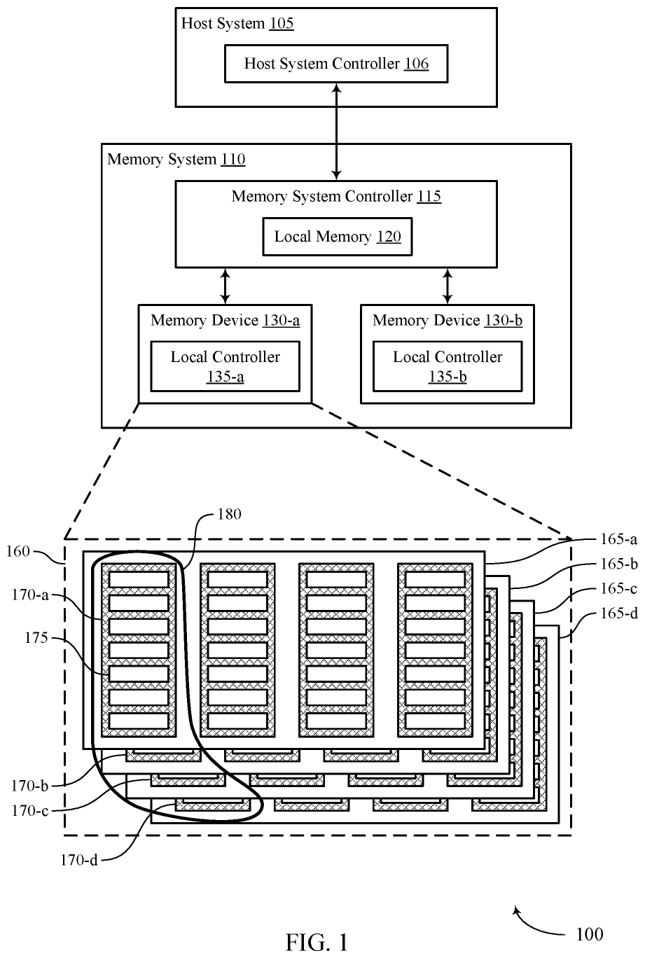

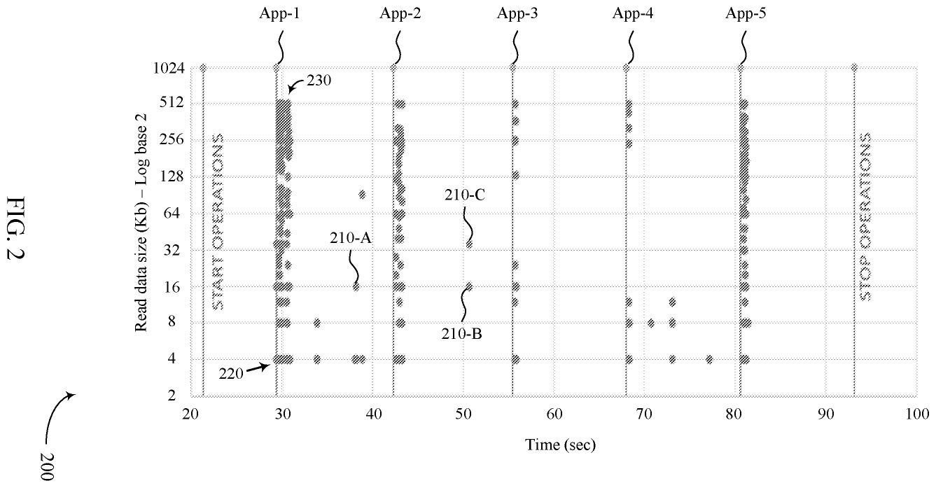

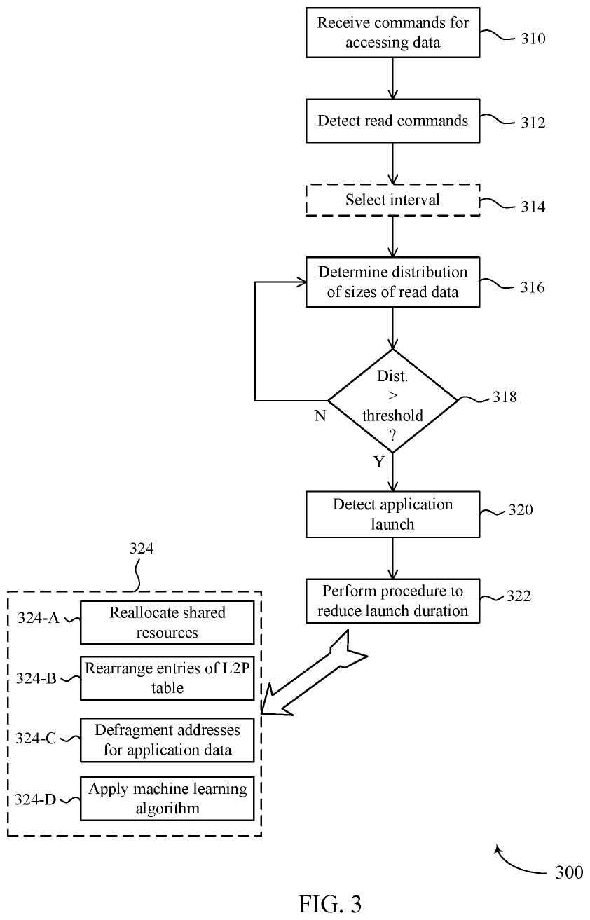

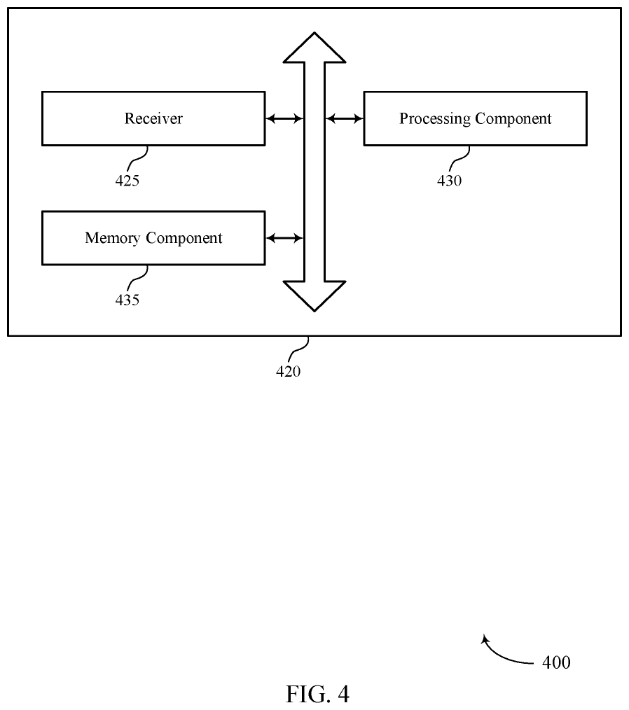

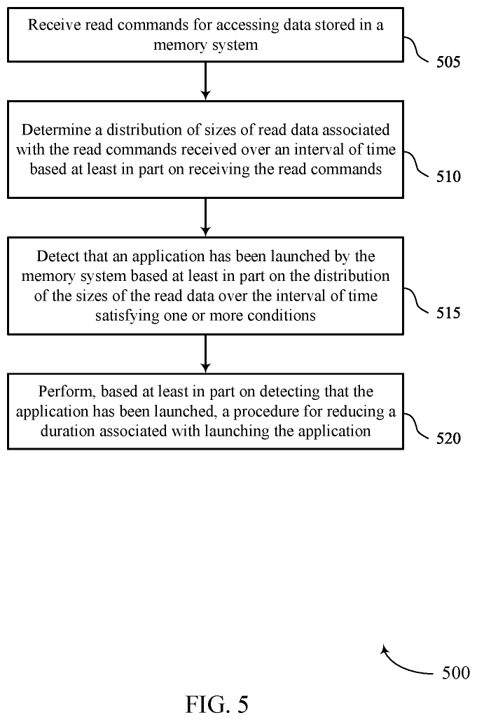

Features of the disclosure are initially described in the context of systems, devices, and circuits with reference to FIG. 1. Features of the disclosure are described in the context of read commands and read data distribution, and a flowchart that related to app launch detection with reference to FIGS. 2 and 3. These and other features of the disclosure are further illustrated by and described in the context of an apparatus diagram and flowchart that relate to app launch detection from read chunk analysis with reference to FIGS. 4 and 5.

FIG. 1 illustrates an example of a system 100 that supports app launch detection from read chunk analysis in accordance with examples as disclosed herein. The system 100 includes a host system 105 coupled with a memory system 110.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other possibilities.

The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations-which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (RAM) (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on a same die or within a same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170, and in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at the page level of granularity) but may be erased at a second level of granularity (e.g., at the block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The system 100 may include any quantity of non-transitory computer readable media that support app launch detection from read chunk analysis. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

The system 100 may include any quantity of hardware and software that support detecting the launch of applications based on analysis of read chunks (or read data sizes), as described herein. In some examples, the memory system, 110 may receive commands to access stored data, and analyze the commands to identify read commands. The memory system 110 may use the received read commands to determine a distribution of sizes of associated read data over an interval of time. The memory system 110 may detect the launch of an application based, for example, on the distribution of the sizes of the read data over the interval of time satisfying one or more conditions. Upon detecting the application launch, the memory system may perform a procedure to reduce the duration of time associated with launching the application. In some examples, at least part of the procedure may include reallocation of resources from SRAM included in the local memory 120. In other examples the procedure may include management of the L2P address table to improve and/or accelerate read operations.

FIG. 2 illustrates a chart 200 showing read command and read chunk analysis that support app launch detection in accordance with examples as disclosed herein. In some examples, the chart 200 may show a distribution of read commands for a particular device. The device may correspond to a system such as system 100 illustrated in FIG. 1. The device may be incorporated in, or correspond to, platforms such as mobile platforms, automotive platforms, marine platforms, etc. that require access to data stored within a memory system, such as memory system 110. The chart 200 contains a distribution of read commands for the device over a time period, designated by the X-axis. The chart 200 also provides an indication of different sizes for the read data associated with each read command. In some examples, the size of the read the data associated with each read command can vary from 2 kB to 1024 kB. In some examples, the size of the read data can be greater than 1024 kB. The chart 200 further provides a distribution of read data size in log base 2 format, thereby resulting in 10 measurement points along the Y-axis of the chart 200. In other examples, the size of each read data may be represented in a different format.

According to the example illustrated in FIG. 2, each point on the chart 200 represents read data associated with a read command that is received by the memory system 110. For example, reference numeral 210-A represents a read command that is received by the memory system at approximately 38 seconds. The chart 200 further shows the read command as associated with read data that is 16 kB in size. Read command 210-B may be received by the memory system at about 51 seconds. As shown in the chart 200, read command 210-B may be also corresponds to read data that is 16 kB in size. Read command 210-C corresponds to read data that is also received by the memory system at approximately 51 seconds. Read command 210-C, however, corresponds to read data that is 32 kB in size.

As illustrated in FIG. 2, the chart 200 may show a variety of read commands that are received by the memory system over a period of time. According to an example, the read commands may be received at different frequencies. Such differences can result in sparse or dense distributions of read commands with respect to time. For example, reference numeral 210 identifies a first density of read commands corresponding to read data having a size of 4 kB. The first density of read commands 220 may be received by the memory system over a period of time which begins just prior to 30 seconds and continues just past 30 seconds.

As shown in the chart 200, once the first density of read commands 220 has been received, a short time duration occurs during which the memory system does not receive any read commands for read data having a size of 4 kB. Furthermore, the chart 200 shows examples of read commands being received at different times for read data of various sizes. For example, reference numeral 230 identifies a second density of read commands received at a relatively similar times as the first density of read commands 220. The second density of read commands 230, however, corresponds to read data having a size of 512 kB. The chart 200 further shows a start of operations and a stop of operations. Depending on the specific platform (e.g., mobile platform, automotive platform, etc.) associated with the memory system, such points in time may be representative of a boot completion and initiation of shutdown operations.

According to the examples disclosed herein, the memory system may utilize information indicative of the distribution of sizes of read data associated with the read commands in order to detect the launch of at least one application. The memory system may identify read commands, from among all commands being received, over an interval of time. The interval of time may vary depending on the memory system, platform being used, etc. In some examples, the interval of time may be set during programming and assembly of the particular device or platform. In other examples, the interval of time may be selected through a system menu associated with the device. In further examples, the interval of time may be changed by authorized personnel.

According to the disclosed examples, the memory system may determine if the distribution of sizes of read data over the interval of time satisfies one or more conditions. In at least one example, the condition may correspond to the total number of read commands received over the interval of time. In some examples, the condition may be related to the sizes of read data associated with the read commands over the interval of time. In other examples, the condition may correspond to both the number of read commands, as well as the size of each read command, received during the interval of time. The condition may, therefore, be indicative of the number of: read commands for read data of 4 kB, the number of read commands for read data of 8 kB, the number of read commands for read data of 256 kB, etc. Depending on the specific example and platform, any combination of read data size may be incorporated to establish the conditions. According to at least one example, the condition may be associated with a threshold that may be satisfied. The threshold may correspond to a value for comparison with the total number of read commands received by the memory system over the interval of time. In other examples, the threshold may correspond to an array (or table) which contains a value for each read data size that is used to define the condition. The array may store threshold values for some or all of the read data sizes available to the memory system, or any combination thereof.

According to the examples disclosed herein, the memory system may detect (or identify) the launch of an application based, at least in part, on one or more of the conditions being satisfied. As illustrated in the chart 200, a first application (App-1) may be detected around 30 seconds. The first application contains a dense distribution of read commands during a short interval of time. Additionally, the read commands may be associated with read data having sizes over a wide distribution between 4 kB and 512 kB. In some examples, the read commands associated with the launch of an application may be associated with larger read chunk sizes per read command, as compared with other read commands associated with other processes. At approximately 43 seconds, the memory system may detect the launch of a second application (App-2). According to the disclosed example, App-2 may be associated with a lower number of read commands. Additionally, the read commands may be associated with read data having a smaller number of different sizes. The memory system may further detect the launch of a third application (App-3) and a fourth application (App-4) containing a lower number of read commands than App-1 and App-2. Furthermore, the read data of these applications may be associated with a lower number of size differences. The memory system may also detect the launch of a fifth application (App-5) at approximately 81 seconds. As shown in the chart 200, App-5 may have an increased number of read commands compared to App-3 and App-4. Additionally, the size of the read data associated with the read commands for App-5 may vary across the different entries defined by the Y-axis. The chart 200 further shows read commands at different times which do not correspond to the launch of an application. Such read commands may be received by the memory system for accessing various data that is not associated with the launch of applications.

Upon detecting that an application has been launched, the memory system may perform one or more procedures that can reduce the total duration of time used to launch the application. According to an example, the memory system may reallocate some of its shared resources to process read commands during the interval of time the application is being launched. The shared resources may be used by the memory system to process at least write commands and read commands. The memory system made therefore reallocate some of the resources used for processing the write commands. The resources may then be available to process the read commands being received during the launch of the application. In some examples, the memory system may include SRAM that is used as a shared resource to process both read commands and write commands. The memory system would therefore reallocate an additional portion of the SRAM to process read commands during the launch of the application.

In some examples, the procedure performed by the memory system may include rearranging entries in a table used to translate logical memory addresses to physical memory addresses. Such a table may be referred to as a L2P (e.g., logical-to-physical) address mapping table, or simply address mapping table. When a read command is received, the read command may include a logical address. Using the logical address, the memory system may identify the physical address (within the memory system) that stores the requested data using the L2P address mapping table. Entries in the address mapping table may map logical address to associated physical address. The address mapping table may be too large to store in SRAM and therefore the address mapping table may be stored in NAND. Portions of the address mapping table may be transferred to the SRAM in response to receiving logical addresses for which physical addresses are to be identified. The process of transferring portions of the address mapping table may increase a latency for performing operations (e.g., read operation). For example, data associated with a particular application may be stored in at logical address 1, 10, 12, 18, 30, and 31. The scattered nature of the logical address may mean that multiple portions of the address mapping table may be transferred into SRAM to perform the read operations. This may increase the latency of performing the read operation. It may therefore be useful for the memory system to arrange information associated with the launch of the application in consecutive logical addresses to reduce a quantity of times the address mapping table is transferred between the SRAM and the NAND.

Transferring portions of the address mapping table between SRAM and NAND may result in latency which may increase the amount of time used to launch the application. The memory system may reduce the amount of time used to access data for the application by rearranging the entries in the address mapping table such that the logical address containing data for the application may be sequentially ordered and therefore may be accessed using fewer transfers of the address mapping table.

According to an example, once the launch of an application is detected, a portion of the address mapping table that includes entries for memory addresses of the read data associated with the application may be transferred in order to reduce the launch duration. This may be an example of pre-fetching some information (e.g., portions of the address mapping table) before various read commands are received. The pre-fetching may increase a quantity of ‘cache hit’ scenarios where the logical address requested by the read command already has its portion of the address mapping table stored in the SRAM. If the memory system includes, for example, SRAM for shared operations, the portion of the address mapping table may be transferred to the SRAM in order to improve the launch speed. In some examples, the memory system may both reallocate some of the shared SRAM used to process write commands in conjunction with transferring portions of the memory table to the reallocated shared memory. The memory system made therefore increase the size of the portion of the address mapping table being transferred to the SRAM. Such an increase may allow the SRAM to accommodate all, or much, of the addresses that include entries for physical addresses of the read data for the application being launched.

According to other examples, the memory system may detect access to the first logical address within the address mapping table that contains the physical address of read data for the application being launched. The memory system may subsequently transfer one or more other portions of the address mapping table that include logical addresses of additional read data for the application being launched. In some examples, the memory system may utilize a multilevel system that contains multiple tables with different levels of granularity. A primary address mapping table may be associated with a low level of granularity (e.g., larger memory address ranges per entry) and a secondary address mapping table may be associated with a higher level of granularity (e.g., smaller memory address ranges per entry). For example, an entry from the primary address mapping table may be associated with a 10,000 memory addresses. The secondary address mapping table may include ten entries to identify memory addresses within the entry of the primary address mapping table. Each entry of the secondary address mapping table may therefore identify 1,000 memory addresses within the primary address mapping table.

According to some examples, the memory system may perform one or more operations (or procedures) to defragment memory addresses that include the read data associated with the launch of one or more applications. The procedures to defragment the memory addresses may include, for example, rearranging information stored in the NAND device so that it is stored in sequential logical address (and/or sequential physical addresses) within the NAND and therefore sequential entries within the address mapping table. This may depend on factors such as the number of pages containing read data for a particular application, data that cannot be moved from certain locations within the memory system, etc. In one example, the application may contain data at four logical addresses, namely logical addresses 3, 9, 12, and 18. The memory system may rearrange the information such that the information stored at sequential logical addresses 1, 2, 3, and 4. Such an ordering may also improve cause the entries in the address mapping table for the information to be sequential as well. Depending on the specific memory system and/or platform been utilized, the operation to rearrange and/or defragment may be performed as part of a background operation by the memory system. Such background operations may include, for example, garbage collection.

According to one or more examples, the threshold value used to detect the launch of an application may be based, at least in part, on the distribution of sizes of read data over successive intervals of time. If the threshold value is based on the total quantity of read commands, the memory system may determine the difference between the total number of read commands within the current interval of time and the total number of read commands received during a different interval (e.g., the previous interval of time). If the threshold is based on the size of read data, the memory system may compare the size of read data received during the current interval of time and the previous interval of time. In some cases, the threshold is based on an average size of the read data included in various read commands. In some cases, the threshold is based on a total size of the read data requested using various read commands. In some examples, the threshold may be based on a combination of read commands and sizes of read data. In such examples, the threshold may be in the form of an array (or table) which stores a threshold value for read commands associated with specific sizes of read data. The array may store a threshold number of read commands for each different size of read data associated with the memory system, or any combination of sizes of read data. Each entry in the array may correspond to a threshold value for the particular read data size which may be satisfied by the difference between the current interval of time and the previous interval of time. Based on the chart 200 illustrated in FIG. 2, the array may store ten threshold values corresponding to: 2 kB, 4 kB, 8 kB, 16 kB, 32 kB, 64 kB, 128 kB, 256 kB, 512 kB, and 1024 kB. In some examples, however, the array may store less than ten threshold values (e.g., 4 kB, 16 kB, 32 kB, 128 kB, 512 kB, and 1024 kB).

According to the examples disclosed herein, the memory system may monitor the launch of different applications over a second interval of time. The second interval of time may correspond to an extended period of time or an ongoing period of time. The memory system may identify one or more applications that have been launched during the second interval. In some examples, the memory system may identify applications that have been launched at least a minimum number of times within the second interval. In other examples, the memory system may identify applications that are associated with higher numbers of read commands. In one example, the memory system may apply one or more a machine learning algorithm to identify such applications based, at least in part, on one or more of the aforementioned criteria. In another example, a combination of machine learning algorithms may be applied. The machine learning algorithms may include, without limitation, least random forest, K nearest neighbors, support vector machine, artificial neural network, ensemble voting classifier, long short-term memory, etc.

The memory system may apply results of the machine learning algorithms to associate the launch of each identified application with particular entries within the address mapping table that include addresses of data for the application. In some examples, the memory system may perform an operation to defragment memory addresses based, at least in part, on results of the machine learning algorithms. Specifically, the memory system may defragment memory addresses that include data for each identified application. This may involve, for example, re-arranging entries in the address mapping table so that pages containing the memory addresses of data associated with each of the identified applications may be arranged in a sequential or near sequential order.

In some examples, it may be desirable to determine whether the memory system is properly detecting the launch of applications. The memory system may, in such examples, detect each application launch and monitor multiple instances of the same application being launched. Next, the memory system may determine the amount of time associated with each successive launch of the same application. According to the examples disclosed herein, the procedures performed by the memory system may result in a reduction for the duration of time associated with launching the application. Accordingly, the memory system may determine whether successive launches of the application occur within a reduced duration of time. Such a reduce duration would be indicative of successful implementation of one or more various procedures in accordance with the examples disclosed herein. In some examples, the reduced duration may be based primarily on the difference between the first launch of the application and a finite number of subsequent launches of the same application (e.g., 2-5 launches, 2-10 launches, etc.). In other examples, successive launch durations may be compared until the resulting difference is below a threshold value for the reduced duration.

FIG. 3 illustrates a flowchart 300 showing steps of a method that supports app launch detection from read chunk analysis in accordance with examples as disclosed herein.

At 310, various commands are received for accessing data. The commands may be received by a memory system, such as memory system 110. The commands may involve various types of operations including, but not limited to, reading data, writing data, deleting data, moving (or relocating) data, etc.

At 312, read commands are detected from all commands received to access the data. According to an example, the memory system may monitor commands being received and identify commands associated with read transactions. In some examples, the memory system may maintain certain statistics regarding the read commands being detected. In one example, the memory system may count the total number of read commands and maintain information pertaining to the value. In other cases, the memory system may maintain information regarding each read command and the size of the read data associated with the read command.

At 314, an interval of time may be selected. The interval of time may correspond to a duration which may be monitored for analysis to determine whether an application has been launched. In some examples, the interval of time may be optionally provided using, for example, trim parameters of the memory system. In other examples, the interval of time may be defined during assembly and initialization of the memory system. In such examples, the interval of time may be fixed or inaccessible by a host system during operation of the memory system. Thus, step 314 may not be performed because the interval of time may not be selectable. In still further examples, the interval of time may be set and/or modified by service or authorized personnel. In such examples, step 314 may be performed after the interval of time has been modified by authorized personnel.

At 316, a distribution of sizes of read data is determined. The distribution of sizes may correspond to the read commands that have been detected by the memory system. For example, each read command may provide an indication of the size of the read data associated therewith. Accordingly, a first read command may be associated with read data having a size of 64 kB. A second read command may be associated with a read data having a size of 512 kB. According to the examples disclosed herein, the memory system may determine the distribution of sizes of read data using the interval of time that is predefined within the memory system, or optionally supplied at 314. For example, if the interval of time is 2 seconds, the memory system would determine a distribution of sizes of read data associated with read commands received every 2 seconds.

At 318, the distribution of sizes is compared to a threshold value in order to determine whether the threshold value (or values) has been satisfied (e.g., exceeded). In some examples, the memory system may perform the comparison between the distribution of sizes and the threshold value to determine whether the value of the distribution exceeds the value of the threshold. The comparison between the distribution and threshold value may take various forms. For example, the distribution may be associated with the total number of read commands received during an interval. Accordingly, the distribution would have an integer value and the threshold value would also be an integer. In some examples, the distribution may include an indication of some or all sizes of read data associated with the memory system. Accordingly, the distribution would be in the form of a table, or vector, which specifies a value for each read data size applied in the distribution. If four different sizes of read data are associated with the distribution, for example, then the table (or array) may include one column which specifies the selected read data size, and another column which specifies the number of read commands associated with each different read data size. Similarly, the threshold value would be formatted as a table which contains a minimum value for each read data size that has been selected for comparison. As previously discussed, the selected data sizes may include some or all ten of the data sizes shown on the Y-axis of the table.

In some examples, the value of each read data size in the distribution may exceed the respective values of each read data size specified in the threshold. In other examples, the test at 318 may be satisfied if 3 out of 4 selected read data sizes in the distribution exceed the corresponding threshold values. If it is determined at 318 that the distribution does not exceed the threshold value, then control returns to 316 where the distribution of sizes of read data for the next interval is determined. If the distribution exceeds the threshold value, then control passes to 320, where it may be concluded that an application has been launched. In some examples the memory system may perform the test at 318 and conclude that the application has been launched.

In some examples, distributions of sizes of read data may be determined using a quantity of counters associated with different sizes of read data. The possible sizes of read data may be quantized into different buckets or bins. A counter may be associated with each bin of read sizes. As read commands requesting different sizes of data are received, the respective counters associated with those sizes of data may be incremented. The total distribution of the sizes of read data may be determined using the various counters over the interval of time. Determining whether the distribution of read sizes satisfies a threshold may include determining whether various counters satisfy one or more thresholds.

At 322, a procedure may be performed to reduce the launch duration of the detected application. According to one or more examples, the procedure may involve application of one or more of the operations specified at 324. In one example, the memory system may re-allocate shared resources in order to reduce the amount of time used to launch the application. Such shared resources may include, without limitation, SRAM utilized by the memory system for performing read and write operations. Thus, at 324-A, the memory system may re-allocate some of the SRAM assigned for write operations for increasing the amount of SRAM available to complete the read transactions associated with launch of the application.

According to another example, the memory system may re-arrange entries of its address mapping table (or tables) in order to improve access to the memory addresses used for storing the read data associated with the launched application. This is indicated at 324-B. Depending on the specific configuration of the memory system, multiple address mapping tables may be applied in order to define different levels of granularity to improve access to the memory system. Accordingly, entries may be rearranged within any of the address mapping tables. In one example, the entries may be rearranged such that pages containing the addresses of memory locations for the read data of the application are sequentially or substantially sequentially ordered.

In accordance with another example, the memory system may defragment memory addresses used to store read data for the application (i.e., application data) at 324-C. In one example, the defragmentation may result in rearrangement of pages in the address mapping table which contain memory locations for read data associated with the application. In an example, the memory system may collect information useful for defragmenting the memory addresses while processing different commands for accessing data, and perform the defragmentation as part of a background process such as garbage collection.

According to an example, the memory system may apply a machine learning algorithm at 324-D. The machine learning algorithm may be used to identify specific applications based on correlations between the distribution of read data sizes and memory addresses stored in the address mapping table. For example, the machine learning algorithm may identify multiple distinct applications and determine the correlation with the locations of memory addresses in the address mapping table. The memory system may subsequently utilize the learned correlations to re-arrange entries associated with the addresses of each distinct application. As previously discussed, the memory system may incorporate one or more of the procedures shown at 324 to improve (or reduce) the amount of time used to launch an application, once detected.

FIG. 4 illustrates a block diagram 400 of a memory system 420 that supports app launch detection from read chunk analysis in accordance with examples as disclosed herein. The memory system 420 may be an example of aspects of a memory system as described with reference to FIGS. 1 through 3. The memory system 420, or various components thereof, may be an example of means for performing various aspects of app launch detection from read chunk analysis as described herein. For example, the memory system 420 may include a receiver 425, a processing component 430, a memory component 435, or any combination thereof. Each of these components may communicate, directly or indirectly, with one another (e.g., via one or more buses).

The receiver 425 may be configured as or otherwise support a means for receiving read commands for accessing data stored in a memory system. The processing component 430 may be configured as or otherwise support a means for determining a distribution of sizes of read data associated with the read commands received over an interval of time based at least in part on receiving the read commands. In some examples, the processing component 430 may be configured as or otherwise support a means for detecting that an application has been launched by the memory system based at least in part on the distribution of the sizes of the read data over the interval of time satisfying one or more conditions. In some examples, the processing component 430 may be configured as or otherwise support a means for performing, based at least in part on detecting that the application has been launched, a procedure for reducing a duration associated with launching the application.

In some examples, to support performing the procedure for reducing the duration, the processing component 430 may be configured as or otherwise support a means for reallocating shared resources within the memory system to process the received read commands from processing other functions.

In some examples, to support reallocating the shared resources, the processing component 430 may be configured as or otherwise support a means for reassigning at least a portion of the shared resources available for processing write commands within the memory system to process the received read commands.

In some examples, the memory system includes shared resources including static random access memory available to the memory system for performing read operations and write operations.

In some examples, to support performing the procedure for reducing the duration, the processing component 430 may be configured as or otherwise support a means for rearranging entries of a table for translating logical memory addresses to physical memory addresses based at least part on the distribution of the sizes of the read data over the interval of time satisfying one or more conditions.

In some examples, the processing component 430 may be configured as or otherwise support a means for transferring a portion of the table that includes entries for memory addresses of the read data associated with the launch based on detecting launch of the application.

In some examples, the processing component 430 may be configured as or otherwise support a means for detecting access to a first page within the table containing an address of read data for the application being launched. In some examples, the processing component 430 may be configured as or otherwise support a means for transferring one or more secondary portions of the table that include memory addresses of additional read data for the application being launched.

In some examples, to support performing the procedure for reducing the duration, the processing component 430 may be configured as or otherwise support a means for defragmenting addresses that include the data related to the launch of each application.

In some examples, to support defragmenting the addresses, the processing component 430 may be configured as or otherwise support a means for rearranging one or more pages within a table in a sequential order, the one or more pages including data associated with the launch of the application.

In some examples, defragmenting the addresses is performed as a background operation.

In some examples, to support receiving read commands, the receiver 425 may be configured as or otherwise support a means for receiving commands for accessing data stored in the memory system. In some examples, to support receiving read commands, the memory component 435 may be configured as or otherwise support a means for monitoring for read commands included in the received commands.

In some examples, to support determining the distribution of the sizes of the read data, the processing component 430 may be configured as or otherwise support a means for determining a frequency of each size within the distribution of the read data associated with the read commands over the interval of time.

In some examples, the processing component 430 may be configured as or otherwise support a means for determining that the distribution of the sizes of the read data exceeds a first threshold value based at least in part on determining the distribution of the sizes of the read data, where detecting that the application has been launched is based at least in part on the determining.

In some examples, the first threshold value is based at least in part on the distribution of the sizes of the read data and a frequency of each size within the distribution of the read data.

In some examples, the processing component 430 may be configured as or otherwise support a means for determining that a difference in the distribution of the sizes of the read data over successive intervals exceeds a second threshold value, where detecting that the application is launched is based at least in part on determining that the difference exceeds the second threshold value.

In some examples, the second threshold value is based at least in part on the distribution of the sizes of the read data and a difference in frequency of each size in the distribution of the read data.

In some examples, the processing component 430 may be configured as or otherwise support a means for monitoring launches of applications over a second interval of time. In some examples, the processing component 430 may be configured as or otherwise support a means for applying a machine learning algorithm to identify one or more applications that have been launched and associating entries within a logical-to-physical table that include addresses of read data for each identified application.

In some examples, the processing component 430 may be configured as or otherwise support a means for defragmenting addresses that include data for each identified application stored in the memory system based at least in part on applying the machine learning algorithm.

In some examples, the processing component 430 may be configured as or otherwise support a means for monitoring successive launches of the application. In some examples, the processing component 430 may be configured as or otherwise support a means for determining a second duration associated with completing each successive launch of the application.

FIG. 5 illustrates a flowchart showing a method 500 that supports app launch detection from read chunk analysis in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving read commands for accessing data stored in a memory system. The operations of 505 may be performed in accordance with examples as disclosed herein. In some examples, aspects of the operations of 505 may be performed by a receiver 425 as described with reference to FIG. 4.

At 510, the method may include determining a distribution of sizes of read data associated with the read commands received over an interval of time based at least in part on receiving the read commands. The operations of 510 may be performed in accordance with examples as disclosed herein. In some examples, aspects of the operations of 510 may be performed by a processing component 430 as described with reference to FIG. 4.

At 515, the method may include detecting that an application has been launched by the memory system based at least in part on the distribution of the sizes of the read data over the interval of time satisfying one or more conditions. The operations of 515 may be performed in accordance with examples as disclosed herein. In some examples, aspects of the operations of 515 may be performed by a processing component 430 as described with reference to FIG. 4.

At 520, the method may include performing, based at least in part on detecting that the application has been launched, a procedure for reducing a duration associated with launching the application. The operations of 520 may be performed in accordance with examples as disclosed herein. In some examples, aspects of the operations of 520 may be performed by a processing component 430 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for receiving read commands for accessing data stored in a memory system; determining a distribution of sizes of read data associated with the read commands received over an interval of time based at least in part on receiving the read commands; detecting that an application has been launched by the memory system based at least in part on the distribution of the sizes of the read data over the interval of time satisfying one or more conditions; and performing, based at least in part on detecting that the application has been launched, a procedure for reducing a duration associated with launching the application.
Aspect 2: The method, apparatus, or non-transitory computer-readable medium of aspect 1, where performing the procedure for reducing the duration further includes operations, features, circuitry, logic, means, or instructions, or any combination thereof for reallocating shared resources within the memory system to process the received read commands from processing other functions.
Aspect 3: The method, apparatus, or non-transitory computer-readable medium of aspect 2, where reallocating the shared resources further includes operations, features, circuitry, logic, means, or instructions, or any combination thereof for reassigning at least a portion of the shared resources available for processing write commands within the memory system to process the received read commands.
Aspect 4: The method, apparatus, or non-transitory computer-readable medium of any of aspects 1 through 3, where the memory system includes shared resources including static random access memory available to the memory system for performing read operations and write operations.
Aspect 5: The method, apparatus, or non-transitory computer-readable medium of any of aspects 1 through 4, where performing the procedure for reducing the duration further includes operations, features, circuitry, logic, means, or instructions, or any combination thereof for rearranging entries of a table for translating logical memory addresses to physical memory addresses based at least part on the distribution of the sizes of the read data over the interval of time satisfying one or more conditions.
Aspect 6: The method, apparatus, or non-transitory computer-readable medium of aspect 5, further including operations, features, circuitry, logic, means, or instructions, or any combination thereof for transferring a portion of the table that includes entries for memory addresses of the read data associated with the launch based on detecting launch of the application.
Aspect 7: The method, apparatus, or non-transitory computer-readable medium of any of aspects 5 through 6, further including operations, features, circuitry, logic, means, or instructions, or any combination thereof for detecting access to a first page within the table containing an address of read data for the application being launched and transferring one or more secondary portions of the table that include memory addresses of additional read data for the application being launched.
Aspect 8: The method, apparatus, or non-transitory computer-readable medium of any of aspects 1 through 7, where performing the procedure for reducing the duration further includes operations, features, circuitry, logic, means, or instructions, or any combination thereof for defragmenting addresses that include the data related to the launch of each application.
Aspect 9: The method, apparatus, or non-transitory computer-readable medium of aspect 8, where defragmenting the addresses further includes operations, features, circuitry, logic, means, or instructions, or any combination thereof for rearranging one or more pages within a table in a sequential order, the one or more pages including data associated with the launch of the application.
Aspect 10: The method, apparatus, or non-transitory computer-readable medium of any of aspects 8 through 9, where defragmenting the addresses is performed as a background operation.
Aspect 11: The method, apparatus, or non-transitory computer-readable medium of any of aspects 1 through 10, where receiving read commands includes operations, features, circuitry, logic, means, or instructions, or any combination thereof for receiving commands for accessing data stored in the memory system and monitoring for read commands included in the received commands.
Aspect 12: The method, apparatus, or non-transitory computer-readable medium of any of aspects 1 through 11, where determining the distribution of the sizes of the read data further includes operations, features, circuitry, logic, means, or instructions, or any combination thereof for determining a frequency of each size within the distribution of the read data associated with the read commands over the interval of time.
Aspect 13: The method, apparatus, or non-transitory computer-readable medium of any of aspects 1 through 12, further including operations, features, circuitry, logic, means, or instructions, or any combination thereof for determining that the distribution of the sizes of the read data exceeds a first threshold value based at least in part on determining the distribution of the sizes of the read data, where detecting that the application has been launched is based at least in part on the determining.
Aspect 14: The method, apparatus, or non-transitory computer-readable medium of aspect 13, where the first threshold value is based at least in part on the distribution of the sizes of the read data and a frequency of each size within the distribution of the read data.
Aspect 15: The method, apparatus, or non-transitory computer-readable medium of any of aspects 1 through 14, further including operations, features, circuitry, logic, means, or instructions, or any combination thereof for determining that a difference in the distribution of the sizes of the read data over successive intervals exceeds a second threshold value, where detecting that the application is launched is based at least in part on determining that the difference exceeds the second threshold value.
Aspect 16: The method, apparatus, or non-transitory computer-readable medium of aspect 15, where the second threshold value is based at least in part on the distribution of the sizes of the read data and a difference in frequency of each size in the distribution of the read data.
Aspect 17: The method, apparatus, or non-transitory computer-readable medium of any of aspects 1 through 16, further including operations, features, circuitry, logic, means, or instructions, or any combination thereof for monitoring launches of applications over a second interval of time and applying a machine learning algorithm to identify one or more applications that have been launched and associating entries within a logical-to-physical table that include addresses of read data for each identified application.
Aspect 18: The method, apparatus, or non-transitory computer-readable medium of aspect 17, further including operations, features, circuitry, logic, means, or instructions, or any combination thereof for defragmenting addresses that include data for each identified application stored in the memory system based at least in part on applying the machine learning algorithm.
Aspect 19: The method, apparatus, or non-transitory computer-readable medium of any of aspects 1 through 18, further including operations, features, circuitry, logic, means, or instructions, or any combination thereof for monitoring successive launches of the application and determining a second duration associated with completing each successive launch of the application.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” refers to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

As used herein, the term “substantially” means that the modified characteristic (e.g., a verb or adjective modified by the term substantially) need not be absolute but is close enough to achieve the advantages of the characteristic.

As used herein, the term “electrode” may refer to an electrical conductor, and in some examples, may be employed as an electrical contact to a memory cell or other component of a memory array. An electrode may include a trace, wire, conductive line, conductive layer, or the like that provides a conductive path between elements or components of a memory array.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims. For example, due to the nature of software, the described functions can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
a controller associated with a memory device, wherein the controller is configured to cause the apparatus to:
receive read commands for accessing data stored in a memory system;
determine a distribution of sizes of read data associated with the read commands received over an interval of time based at least in part on receiving the read commands;
detect that an application has been launched by the memory system based at least in part on the distribution of the sizes of the read data over the interval of time satisfying one or more conditions; and
perform, based at least in part on detecting that the application has been launched, a procedure for reducing a duration associated with launching the application.

2. The apparatus of claim 1, wherein the controller is further configured to perform the procedure for reducing the duration by causing the apparatus to:
reallocate shared resources within the memory system to process the received read commands from processing other functions.

3. The apparatus of claim 2, wherein the controller is further configured to reallocate the shared resources by causing the apparatus to:
reassign at least a portion of the shared resources available for processing write commands within the memory system to process the received read commands.

4. The apparatus of claim 1, wherein the memory system comprises shared resources comprising static random access memory available to the memory system for performing read operations and write operations.

5. The apparatus of claim 1, wherein the controller is further configured to perform the procedure for reducing the duration by causing the apparatus to:
rearrange entries of a table for translating logical memory addresses to physical memory addresses based at least part on the distribution of the sizes of the read data over the interval of time satisfying one or more conditions.

6. The apparatus of claim 5, wherein the controller is further configured to cause the apparatus to:
transfer a portion of the table that includes entries for memory addresses of the read data associated with the launch based on detecting launch of the application.

7. The apparatus of claim 5, wherein the controller is further configured to cause the apparatus to:
detect access to a first page within the table containing an address of read data for the application being launched; and
transfer one or more secondary portions of the table that include memory addresses of additional read data for the application being launched.

8. The apparatus of claim 1, wherein the controller is further configured to perform the procedure for reducing the duration by causing the apparatus to:
defragment addresses that include the data related to the launch of each application.

9. The apparatus of claim 8, wherein the controller is further configured to defragment the addresses by causing the apparatus to:
rearrange one or more pages within a table in a sequential order, the one or more pages including data associated with the launch of the application.

10. The apparatus of claim 8, wherein the controller is configured to defragment the addresses as part of a background operation.

11. The apparatus of claim 1, wherein
the controller is further configured to receive read commands by causing the apparatus to:
receive commands for accessing data stored in the memory system; and
monitor for read commands included in the received commands.

12. The apparatus of claim 1, wherein the controller is further configured to determine the distribution of the sizes of the read data by causing the apparatus to:
determine a frequency of each size within the distribution of the read data associated with the read commands over the interval of time.

13. The apparatus of claim 1, wherein the controller is further configured to cause the apparatus to:
determine that the distribution of the sizes of the read data exceeds a first threshold value based at least in part on determining the distribution of the sizes of the read data, wherein detecting that the application has been launched is based at least in part on the determining.

14. The apparatus of claim 13, wherein the first threshold value is based at least in part on the distribution of the sizes of the read data and a frequency of each size within the distribution of the read data.

15. The apparatus of claim 1, wherein the controller is further configured to cause the apparatus to:
determine that a difference in the distribution of the sizes of the read data over successive intervals exceeds a second threshold value, wherein detecting that the application is launched is based at least in part on determining that the difference exceeds the second threshold value, wherein the second threshold value is based at least in part on the distribution of the sizes of the read data and a difference in frequency of each size in the distribution of the read data.

16. The apparatus of claim 1, wherein the controller is further configured to cause the apparatus to:
monitor launches of applications over a second interval of time; and
apply a machine learning algorithm to identify one or more applications that have been launched and associating entries within a logical-to-physical table that include addresses of read data for each identified application.

17. The apparatus of claim 17, wherein the controller is further configured to cause the apparatus to:
defragment addresses that include data for each identified application stored in the memory system based at least in part on applying the machine learning algorithm.

18. The apparatus of claim 1, wherein the controller is further configured to cause the apparatus to:
monitor successive launches of the application; and
determine a second duration associated with completing each successive launch of the application.

19. A method, comprising:
receiving read commands for accessing data stored in a memory system;
determining a distribution of sizes of read data associated with the read commands received over an interval of time based at least in part on receiving the read commands;
detecting that an application has been launched by the memory system based at least in part on the distribution of the sizes of the read data over the interval of time satisfying one or more conditions; and
performing, based at least in part on detecting that the application has been launched, a procedure for reducing a duration associated with launching the application.

20. A non-transitory computer-readable medium storing code, the code comprising instructions executable by a processor to:
receive read commands for accessing data stored in a memory system;
determine a distribution of sizes of read data associated with the read commands received over an interval of time based at least in part on receiving the read commands;
detect that an application has been launched by the memory system based at least in part on the distribution of the sizes of the read data over the interval of time satisfying one or more conditions; and
perform, based at least in part on detecting that the application has been launched, a procedure for reducing a duration associated with launching the application.
